(19) United States
(12) Patent Application Publication
(10) Pub. No.: US 2014/0072676 A1
(43) Pub. Date: Mar. 13, 2014

(54) CAPSULE FOR PERCOLATING AN AROMATIC PRODUCT SUCH AS COFFEE

(71) Applicant: Tirouvady Moutty, Franconville (FR)

(72) Inventor: Tirouvady Moutty, Franconville (FR)

(21) Appl. No.: 14/042,422

(22) Filed: Sep. 30, 2013

Related U.S. Application Data
(63) Continuation of application No. 13/129,410, filed on Jul. 12, 2011, now abandoned.

(30) Foreign Application Priority Data
Nov. 17, 2008 (FR) 0857805

(51) Int. Cl. B65D 85/804; A47J 31/40

(52) U.S. Cl. CPC B65D 85/8043; B65D 85/8046; A47J 31/407
USPC 426/112; 99/295

(57) ABSTRACT

Capsule for percolation of aromatic product (18) such as coffee, comprising a bottom (3), a side wall (2) and a cover (4) delimiting an internal volume (19) of the capsule, and made of a material that is sealed against the infiltration of air so as to conserve the aromatic product designed to be enclosed in the internal volume. The capsule can be perforated by a percolator. The bottom (3) can be deformed in the percolator. The bottom (3) and the side wall (2) are made of portions previously separate and fixed in a sealed manner by a surface zone (2b, 11a) common to the side wall and to the bottom.

The invention relates to the field of containers of aromatic product, such as coffee, tea, herbal teas for infusion with hot water.

There are two families of container, filter-paper sachets and capsules for a percolator.

The infusion sachets allow the hot water to pass through. The product is infused with hot water at atmospheric pressure. Such sachets are usually made of filter paper and are optionally packaged in another container in order to conserve the aroma of the product to be infused.

Coffee machines, such as that described in patent application FR 2 885 288, use sachets of the above type. The sachet is placed in a closed enclosure suitable for the sachet and pressurized water is delivered from one side and infused liquid is collected on the other side. The machine using filter-paper sachets does not pierce the sachet. The hot water passes through the filter paper. The water pressure used for the infusion is moderate and the coffee contained in the sachet is moderately compacted.

The invention relates more particularly to capsules for a percolator. Such capsules are usually rigid and sealed. The coffee, or the product for percolation that they contain, is usually greatly compacted.

Document EP 1 669 011 describes a head of an espresso machine. In the machine, a first injection punch pierces the capsule and delivers pressurized hot water. Another collection punch also pierces the capsule and collects the infused liquid that has passed through a compact coffee at high pressure. This notably makes it possible to make coffee of the espresso type. Such capsules are for use once only and are discarded after use. This poses a problem of processing the waste that the capsule represents after use.

Patent application WO 2006/003115 describes an infusion method with a coffee capsule. The capsule described is made of thermoplastic. Such capsules are particularly harmful to the environment because the untreatable waste occupies the whole volume of the capsule. What is worse is that the coffee inside the capsule is naturally biodegradable. Other capsules exist that are aluminium-alloy based.

The invention proposes a capsule for percolation of aromatic product such as coffee, which capsule is less harmful to the environment.

According to one embodiment, the capsule for percolation of aromatic product such as coffee comprises a bottom, a side wall and a cover delimiting an internal volume of the capsule, and made of a material that is sealed against the infiltration of air so as to conserve the aromatic product designed to be enclosed in the internal volume. The capsule can be perforated by a percolator. The bottom can be deformed in the percolator. The bottom and the side wall are made of portions previously separate and fixed in a sealed manner by a surface zone common to the side wall and to the bottom.

By virtue of the fact that the bottom is fixed on the surface to the side wall, the capsule performs its function of sealed container before it is inserted into the percolator. Since the bottom is deformable, and fixed by its surface to the surface of the side wall, the deformation in the percolator weakens the connection between the bottom and the side wall. This makes it easier to break open the capsule after use, which makes it possible to release the remaining coffee dregs. This reduces the volume of material capable of harming the environment.

Advantageously, the side wall is of frustoconical shape about an axis of the capsule, the cover and the bottom being substantially perpendicular to the said axis, the bottom extending on the side with the smallest diameter of the frustoconical shape.

Advantageously, the surface zone common to the side wall and to the bottom has a skirt shape protruding on the outside of the internal volume of the capsule and extending parallel about the axis of the capsule.

This skirt allows the collection punches of the percolator to be housed under the bottom of the capsule. The perforation of the capsule by the punches does not risk taking place before the cavity of the percolator is closed. This prevents mechanically stressing the bottom before the percolation has truly begun. This makes it possible to keep the pressurized hot water in the compacted coffee before the collection punches penetrate the internal volume of the capsule.

Advantageously, the axial height of the skirt is between 10% and 15%, preferably between 12% and 14%, for example 13%, of the diameter of the bottom of the capsule. The surface fixing between the bottom and the side wall is therefore made on a surface such that it provides a good mechanical cohesion to the capsule before use.

Advantageously, the axial height of the skirt is between 10% and 20%, preferably between 14% and 18%, for example 16%, of the axial height of the capsule. This makes it possible to increase the compactness of the product contained in the capsule without changing either the quantity of product contained or the external volume of the capsule relative to the capsules normally used in the coffee machines. This allows the capsules of the invention to use the existing percolators suitable for the external volume of the capsule.

Advantageously, the side wall has a top connecting rim, the cover being previously separate from the side wall and fixed to the top connecting rim by a common surface zone.

According to one embodiment, the side wall and/or the bottom and/or the cover consists of a main layer made of a main material covered on one side with a heat-sealable plastic film.

This embodiment is particularly advantageous for the environment. The main material can be degraded during the reprocessing of the used capsule. In particular, the percolation helps to dampen the main material. This makes it easier for the main material to begin to degrade and promotes the breaking open of the capsule, the release of the used product and the reprocessing of all the items.

Advantageously, the said film is compatible with food contact. “Compatible with food contact” means a material that conforms to European directive 2002/72/CE, or to American specification US FDA 176.170. That is to say that the material of the side wall, and/or of the bottom and/or of the cover in its entirety does not give rise to significant migrations into a stimulant food. In particular, and depending on the application of the capsule, it is desirable for the material to be suitable for food stuffs that are hot, wet, dry or fatty. Conformity with a use in a bakery is not required for a use of the capsule in coffee machines. According to the standards in question, compatibility with food contact may also include a quantity of heavy metals that is below a standard threshold. Compatibility with food contact may also include resistance to mechanical bending. Therefore compatibility with food contact is not degraded by the process of preforming, assembling and filling of the capsule.

Advantageously, the said film is placed in the capsule on the side of the internal volume.

Advantageously, the main material is biodegradable, preferably cardboard. “Biodegradable” means conformity with the EPA (Environment Protection Agency—USA) rules. In particular, it may comprise traces of chlorine and of dioxin below a standard threshold. Biodegradability in particular provides the material with the ability to degrade mechanically so that the capsule breaks open naturally after use. Biodegradability is a mechanical weakening means that can be initiated. Therefore, after use, the not only the material of the capsule itself dissolves into nature but, in doing so, it allows the content of the capsule to dissolve into nature also.

Advantageously, the cover and the side wall are made of the same material. This makes it possible to obtain a virtually complete reprocessing of the capsule.

Advantageously, the heat-sealable plastic film is a polypropylene film with a thickness of less than 1/10th, and preferably of less than 1/30th, of the total thickness of the main material.

Advantageously, the thickness of the main material is less than 0.5 mm and in particular less than 0.3 mm.

According to one embodiment, the capsule comprises the aromatic product for percolation, compacted in the totality of the internal volume, preferably with a density greater than 0.3 g/cm³. The product contained may for example be in the form of grounds or of powders.

According to one embodiment, the capsule comprises the aromatic product taken from coffee, tea, natural lemon tea, green tea, mint tea or one or more kinds of herbal tea. Such capsules may also contain water-soluble products, such as cocoa powder or milk or milk powder.

Other features and advantages of the invention will become evident on reading the detailed description of several embodiments taken as non-limiting examples and illustrated by the appended drawings, in which:

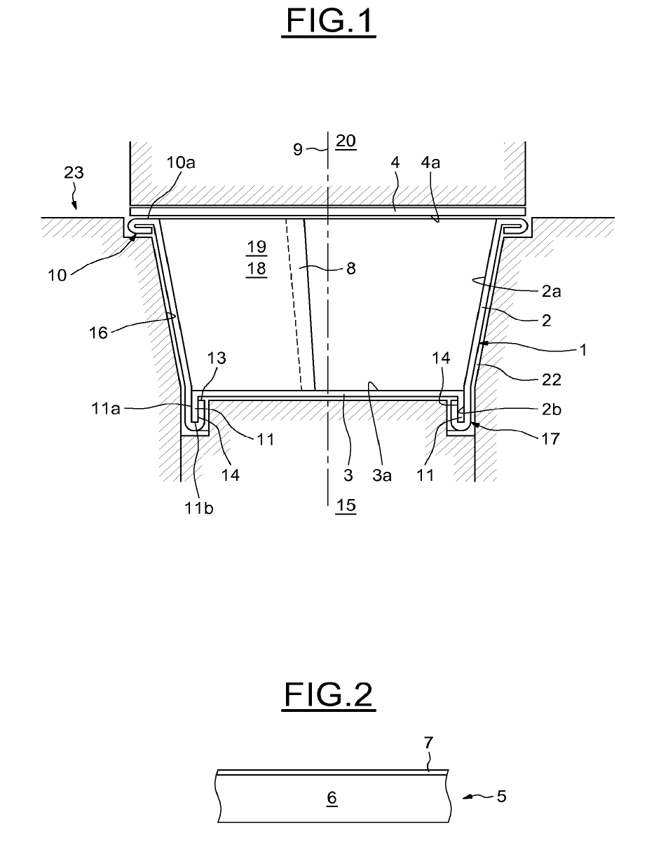

FIG. 1 is an illustration of the capsule ready to be filled;

FIG. 2 is a section of the material of the capsule;

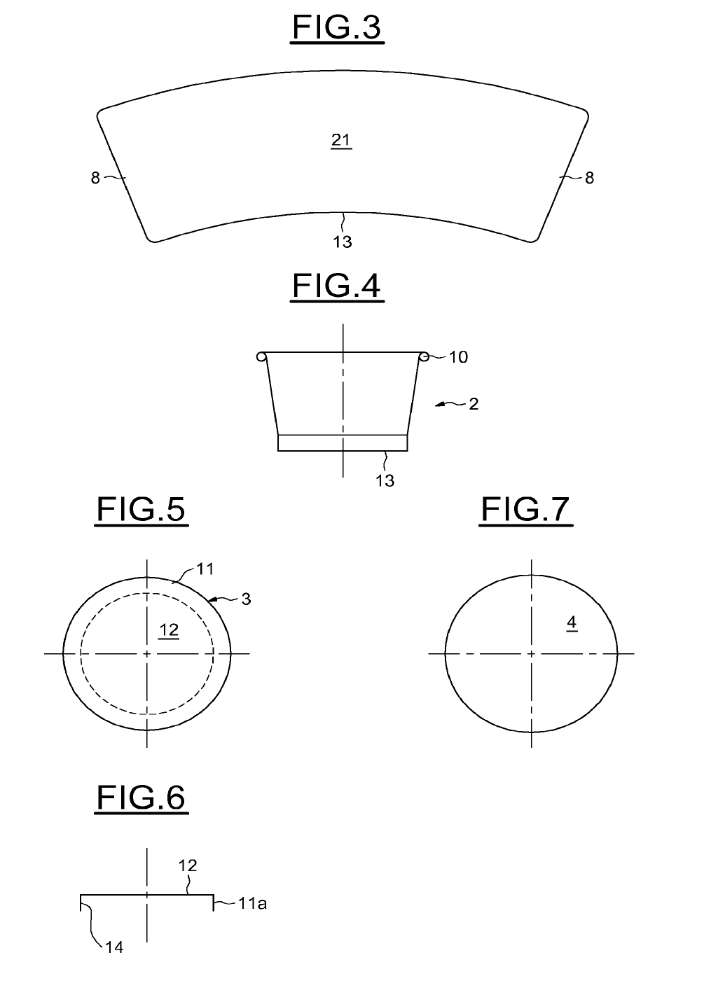

FIG. 3 is an opened-out illustration of the side wall before preassembly;

FIG. 4 is an external view of the preformed side wall before assembly of the capsule;

FIG. 5 is a view from above of the bottom of the capsule before preforming;

FIG. 6 is a section of the bottom of the capsule after preforming;

FIG. 7 is a view from above of the cover;

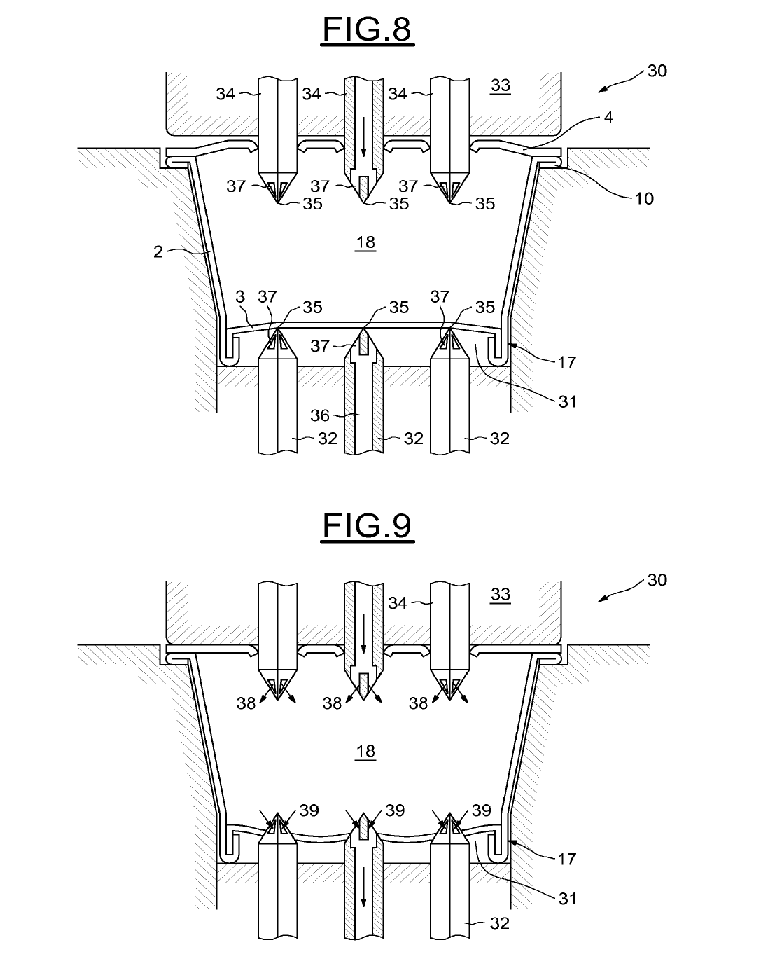

FIG. 8 is a section of the capsule and of the percolator in the percolator closure phase; and

FIG. 9 is a section of the capsule and of the percolator during percolation.

A method of manufacturing the capsule 1 will be described with the aid of FIGS. 1 to 7. The latter is made of three elements that are initially separate before being preformed and then assembled. The capsule 1 comprises three elements which are a side wall 2, a bottom 3 and a cover 4. Each of the three elements 2, 3, 4 of the capsule is made of a cut sheet 5 illustrated in FIG. 2. The cut sheet 5 is made of a main material 6 covered with a heat-sealable plastic film 7. The method of laminating the sheet 5 is such that the film 7 is closely associated with the main material 6 over the whole surface area of the surface of the blank of the sheet 5. The sheet 5 is laminated on only one side of the sheet.

Thus, each of the three elements 2, 3, 4 has a laminated side respectively 2a, 3a, 4a and a side on which the main material 6 is in the raw state. The laminated side is compatible with food contact. The sheet 5 can be made of biodegradable food cardboard, such as the material “Indobarr 1PE®” from ITC.

The side wall 2, in the deployed state, has the shape of a circularly arcuate strip 21 illustrated in FIG. 3, so that, when being folded on itself and sealed by its ends 8, the side wall 2 has a frustoconical shape with one side of smaller diameter designed to receive the bottom 3 and one side of larger diameter designed to receive the cover 4. The two ends 8 of the side wall 2 are stuck together by heat sealing the film 7 of one end 8 onto the portion made of main material 6 of the other end of the circularly arcuate strip 2. The frustoconical shape of the side wall 2 is substantially symmetrical of revolution about an axis 9 of the capsule 1. The folding of the circularly arcuate strip 2a by its ends 8 is such that the laminated side 2a is on the internal side of the side wall 2, that is to say on the side of the axis 9 of the capsule.

A torus-shaped top rim 10 is formed in the upper portion of the capsule 1, that is to say on the side of the larger diameter of the frustoconical shape. This torus-shaped rim 10 is formed for example by a corresponding torus-shaped punch or by a thumbwheel.

The bottom 3 has an initial shape of a disc in which rims 11 are curved on the side opposite to the film 7 of the face 3a as illustrated in

FIGS. 5 and 6. The bottom 3 thus preformed is inserted into the frustoconical shape of the side wall 2 so that a central portion 12 of the bottom 3 is substantially perpendicular to the axis 9 of the capsule 1 and one axial end 11b of the rim 11 of the bottom 3 is substantially parallel to and at a distance from the bottom edge 13 of the side wall 2. The bottom edge 13 of the strip 21 in the shape of a truncated cone is folded in the direction of the axis 9 of the capsule 1 and then pressed onto an internal face 14 of the rim 11.

The laminated face 2a of the side wall 2 has a surface zone 2b facing the rim 11 of the bottom 3. A thumbwheel not shown makes it possible to press the rim 11 of the bottom 3 and sandwich it between the bottom edge 13 of the strip 21 in the shape of a truncated cone and the surface zone 2b of this same side wall 2. Therefore, the surface zone 2b of the laminated face 2a of the side wall 2 and the laminated side 11a of the rim 11 of the bottom are sealed together and form a surface common to the side wall 2 and to the bottom 3. This heat sealing makes it possible to ensure the seal between the bottom 3 and the side wall 2. The laminated face 3a of the bottom 3 and the laminated face 2a of the side wall 2 are therefore in continuity and define, with the cover 4, an internal volume 19 of the capsule 1. The rim 11 of the bottom, the portion 2b of the side wall 2 and the bottom rim 13 form a skirt 17 extending axially on the outside of the capsule 1.

The method of filling and of closing the capsule 1 will now be described. The sealed side wall 2 with the bottom 3 as described above is inserted into a cavity 22 of a tool 23 for filling the capsule 1. This filling tool 23 comprises an internal piston 15 and a frustoconical bore 16 with a shape corresponding to the side wall 2 in order to form the cavity 22. The internal piston 15 has a peripheral crank making it possible to receive the skirt 17. The internal piston 15 therefore closely follows the shape of the bottom 3 so that it is possible to compact, inside the capsule 2, the product 18 taking the form of grounds or powders. This makes it possible to reduce the mechanical stress of the seals of the bottom 3 and of the ends 8 for assembling the side wall 2.

The film 7 is made of material compatible with food contact. The product 18 may be coffee, tea, which may or may not be coated with natural lemon or artificial flavour, green tea, mint tea, cocoa powder or powdered milk. The filling of the internal volume 19 of the capsule 1 can be carried out by successive compactings of several layers of product 18, or else by precompacting in a piston not shown which discharges into the internal volume 19 of the already compressed product 18. However, although the main use of the capsule is to contain compacted products, the capsule 1 is not restricted to containing such products. It may also contain liquid products such as milk or cream. Such a capsule could be used for containing detergent, and more generally any kind of product that has to be packaged in a sealed manner for each dose.

Whatever method is envisaged for compacting the product 18, the latter, in the compressed state, comes flush with the top rim 10. The cover 4 is placed so that its laminated side 4a is in contact with the product 18 and with the torus-shaped rim 10. An external piston 20 compresses the assembly and allows one laminated external zone 4a of the cover 4 to be heat sealed on an equally laminated zone 10a of the torus-shaped rim 10 of the side wall 2. This heat sealing ensures the mechanical closure and sealing of the capsule 1 while the product 18 occupies the whole internal volume 19 of the capsule 1.

According to one embodiment, the capsule 1 has an axial height of 25 mm and a bottom diameter of 30 mm, and a cover diameter of 40 mm after assembly. In other words, the circularly arcuate strip 2a is approximately 36 mm in width, allowing the formation of both the internal edge 13 and of the torus-shaped rim 10. The aromatic product 18 may be compacted in the whole internal volume 19 with a density of more than 0.3 g/cm³. This makes it possible to place 6.5 g of coffee in a capsule with the aforementioned dimensions. The heat-sealable plastic film 7 may be a polypropylene film with a thickness of less than 1/10th, and preferably less than 1/30th, of the total thickness of the main material 6. The thickness of the main material 6 may be less than 0.5 mm and in particular less than 0.3 mm.

Now, with the aid of FIGS. 8 and 9, one use of the capsule 1 in a percolator 30 will be described. The latter has a cavity 31 corresponding to the shape of the capsule 1 at the bottom of which a series of collection punches 32 are placed. A top portion 33 of the percolator 30 is provided with a series of injection punches 34.

Each of the collection punches 32 and injection punches 34 has a pointed shape at the end 35 and an internal nozzle 36 leading into the pointed portion at the end 35 through holes 37.

In a first percolation step, the capsule 1 is inserted into the cavity 31. When the latter is not pressed by the top portion 33 of the percolator, the bottom 3 of the capsule 1 rests on the pointed portions 35 of the collection punches 32. In a preliminary phase of closing the top portion 33 illustrated in FIG. 8, the injection punches 34 perforate the cover 4 of the capsule 1 and penetrate the internal volume 19 filled with product 18. This perforation force slightly deforms the capsule 1 and the top portion 33 presses the cover 4 of the capsule 1 so as to ensure the sealing of the cavity 31.

Depending on the features of the desired coffee, it is possible to adjust the moment of the phase for closing the percolator 30 during which the collection punches 32 of the cavity 31 perforate the bottom 3 of the capsule 1 in their turn.

Pressurized hot water 38 at a temperature of approximately 90° under 20 bar is injected through the injection punches 34 into the compacted product 18. The phenomenon of percolation begins and the deformation of the bottom 3 increases. At this moment, the collection punches 32 have completely perforated the bottom 3 so that the water 39 originating from the percolation is collected through the holes 37 of the collection punches 32.

After the percolation, the capsule 1, perforated both through its cover and through its bottom 3, is discarded. In one variant, the capsule is also suitable for percolators in which the injection and/or collection punches are situated elsewhere around the capsule.

It is understood that the biodegradable cardboard of the side wall 2, of the bottom 3 and of the cover 4 begins to degrade as soon as the dregs of product 18, after percolation, begin to soak into the cardboard. Moreover, the deformation caused by the perforations of the collection punches 32 may help to weaken the fixing of the bottom 3 to the side wall 2 so that the degrading of the capsule after use is accelerated.

In a general manner, the invention relates to a capsule 1 suitable for, but not limited to, the percolation of an aromatic product 18 such as coffee. The capsule comprises a bottom 3, a side wall 2 and a cover 4 delimiting an internal volume 19 of the capsule 1. The capsule 1 is made of a material 5 sealed against the infiltration of air so as to conserve the product 18 designed to be enclosed in the internal volume 19. The capsule comprises a means of mechanical weakening that can be initiated by the use of the capsule.

This is particularly useful when the product 18 contained in the capsule is not totally cleared from the capsule during use. By virtue of the means of mechanical weakening that can be initiated by the use of the capsule, the latter can be broken open and can release the rest of the product that was not cleared during use. The said capsule is therefore less harmful to the environment.

The mechanical weakening means that can be initiated may consist of a bottom associated with the side wall by a surface fixing that is likely to crack after the deformation due to use in a percolator.

This weakening means that can be initiated may alternatively, or in combination, consist of a material of one of the elements of the capsule consisting of a sealed film and of a main material, the film being relatively very thin when compared with the main material, and the main material being biodegradable and relatively stronger mechanically than the film. After use, not only the material of the capsule itself dissolves into nature, but, in doing so, it allows the content of the capsule to also dissolve into nature.

1. A capsule for percolation of aromatic product such as coffee, comprising a bottom, a side wall and a cover delimiting an internal volume of the capsule, and made of a material that is sealed against the infiltration of air so as to conserve the aromatic product designed to be enclosed in the internal volume, the capsule being able to be perforated by a percolator, the bottom and the side wall being made of portions previously separate and fixed in a sealed manner by a surface zone common to the side wall and to the bottom, and the bottom being able to be deformed in the percolator, characterized in that the surface zone common to the side wall and to the bottom has a skirt shape protruding on the outside of the internal volume of the capsule and extending parallel about the axis of the capsule.

2. The capsule according to claim 1, in which the side wall is of frustoconical shape about an axis of the capsule, the cover and the bottom being substantially perpendicular to the said axis, the bottom extending on the side with the smallest diameter of the frustoconical shape.

3. The capsule according to claim 2, in which the side wall has a top connecting rim, the cover being previously separate from the side wall and fixed to the top connecting rim by a common surface zone.

4. The capsule according to claim 1, in which the side wall and/or the bottom and/or the cover consists of a main layer made of a main material (6) covered on one side with a heat-sealable plastic film, the said film being compatible with food contact and placed in the capsule on the side of the internal volume.

5. The capsule according to claim 4, in which the main material is biodegradable, preferably cardboard.

6. The capsule according to claim 4 in which the bottom, the cover and the side wall are made of the same material.

7. The capsule according to claim 4 in which the heat-sealable plastic film is a film of polypropylene with a thickness of less than 1/10th, and preferably less than 1/30th, of the total thickness of the main material and/or in which the thickness of the main material is less than 0.5 mm and in particular less than 0.3 mm.

8. The capsule according to claim 1, comprising the aromatic product for percolation, compacted in the totality of the internal volume, preferably with a density greater than 0.3 g/cm³.

9. The capsule according to claim 1, comprising the aromatic product taken from coffee, tea, natural lemon tea, green tea, mint tea or one or more kinds of herbal tea.
